(19) United States
(12) Patent Application Publication
(10) Pub. No.: US 2008/0179769 A1
(43) Pub. Date: Jul. 31, 2008

(54) Repositionable electrode for poling of ferroelectric crystal materials

(76) Inventors: Anthony D. Roberts, Bozeman, MT (US); Philip R. Battle, Bozeman, MT (US)

Correspondence Address: Altera Law Group, LLC, 220 S 6 St Suite 1700, Minneapolis, MN, 55402, US

(21) Appl. No.: 11/698,254

(22) Filed: Jan. 25, 2007

(51) Int. Cl. G02F 1/135

(52) U.S. Cl. 264/1.27; 359/326

(57) ABSTRACT

Optical devices are manufactured by aligning domains, or poled volumes, in specific patterns in a ferroelectric crystal material. The ferroelectric crystal material may be poled in a repeated pattern, using an electrode having a shaped contact area that is essentially the same as a single spatial feature of the pattern such as a line or a triangle, or with a shaped contact area that is smaller than a spatial feature of the pattern, or smaller than all of the spatial features of the pattern. These devices may be produced use a repositionable electrode on one surface of the crystal, rather than a conventional, fixed electrode. The repositionable electrode is positioned on a surface of the crystal, with an opposing electrode on the opposing surface of the ferroelectric crystal material, the ferroelectric crystal material is poled by applying a voltage profile between the electrodes, the repositionable electrode is repositioned to a new location, and the ferroelectric crystal material is poled in the new location. The procedure is repeated for as many instances of the poled feature as desired.

### GOVERNMENT LICENSE RIGHTS

The United States Government has a paid-up license in this invention and the right in limited circumstances to require the patent owner to license others on reasonable terms as provided for by the terms of Contract No. USAF-5806-002-SC-0001 awarded by the United States Air Force.

### BACKGROUND OF THE INVENTION

1. Field of the Invention

The present invention relates to optical devices, and more particularly to poling of ferroelectric crystal materials to create optical devices.

2. Description of the Related Art

The process of reversing domains in specific patterns in a ferroelectric crystal is used to create many useful optical devices. Domain reversal, or poling, is typically accomplished by placing electrodes on the top and bottom surfaces of the ferroelectric crystal, then applying a voltage profile to the electrodes. One surface typically supports an electrode or electrodes covering essentially the whole area to be poled, while the other surface may support a corresponding electrode or electrodes or a ground plane. The applied voltage creates an electric field inside the ferroelectric crystal, and the domains become aligned with the electric field in the regions corresponding more or less to the shape of the electrode. After the applied voltage is discontinued, the domains retain their alignment permanently or until the crystal is re-poled. The electrodes are typically removed upon termination of the poling process.

Unfortunately, the pattern resulting in the poled area does not always correspond sufficiently well or predictably to the electrode shape. Small scale pattern fidelity can be compromised, for example, due to variations in the ferroelectric crystal or crystal-to-electrode contact when domain reversed regions are created over large areas of the surface of the ferroelectric crystal. Pattern fidelity can also be compromised when the electrode pattern contains features of different size and/or shape, inasmuch as the electrical poling voltage profile and current applied to the electrode may not be optimal for all of the features. Therefore, a need exists for improving the fidelity of domain reversed patterns in ferroelectric crystal materials.

Additionally, electrodes may be expensive and time consuming to fabricate. For a style of electrode that is directly deposited on the crystal, a new electrode is fabricated for each poled crystal that is made, which adds expense to the crystal. For a style of electrode that is deposited on or made integral with a separate substrate that is brought into contact with the crystal during poling, a different electrode is fabricated for each different poling pattern that is desired. Accordingly, a need exists for an electrode that can be used to produce many different patterns.

### BRIEF SUMMARY OF THE INVENTION

Each of these and other disadvantages are overcome by one or more of the embodiments of the present invention. One embodiment of the present invention is a method of poling ferroelectric crystal material to form spatial features therein for one or more optical devices, which comprises positioning a repositionable electrode having a shaped contact area in a first location on a first surface of the ferroelectric crystal material; poling the ferroelectric crystal material with the repositionable electrode at the first location to form a first poled volume; positioning the repositionable electrode in a second location different from the first location on the first surface of the ferroelectric crystal material; and poling the ferroelectric crystal material with the repositionable electrode at the second location to form a second poled volume.

Another embodiment of the present invention is a method for poling ferroelectric crystal material to form spatial features therein for one or more optical devices, which comprises positioning a repositionable electrode having a shaped contact area in a first location on a first surface of the ferroelectric crystal material, the shaped contact area being elongated with an aspect ratio greater than 100 to 1; providing a fixed opposing electrode on a second surface of the ferroelectric crystal material, the first and second surfaces being opposing; poling the ferroelectric crystal material with the repositionable electrode at the first location and with the fixed opposing electrode to form a first poled volume; positioning the repositionable electrode in a second location different from the first location on the first surface of the ferroelectric crystal material; and poling the ferroelectric crystal material with the repositionable electrode at the second location and with the fixed opposing electrode to form a second poled volume. The first poled volume and the second poled volume have substantially identical shapes.

Another embodiment of the present invention is a system for poling ferroelectric crystal material to form spatial features therein for one or more optical devices, which comprises a voltage generator; a repositionable electrode coupled to the voltage generator, the repositionable electrode having a shaped contact area; a substrate holder for holding the ferroelectric crystal material; and a controller coupled to at least one of the substrate holder and the repositionable electrode. The controller is configured for positioning the repositionable electrode in a first location on a first surface of the ferroelectric crystal material; poling the ferroelectric crystal material with the repositionable electrode at the first location to form a first poled volume; positioning the repositionable electrode in a second location different from the first location on the first surface of the ferroelectric crystal material; and poling the ferroelectric crystal material with the repositionable electrode at the second location to form a second poled volume.

Another embodiment of the present invention is a system for poling ferroelectric crystal material to form one or more optical devices, which comprises a voltage generator; a repositionable electrode coupled to the voltage generator, the repositionable electrode having an elongated shaped contact area with an aspect ratio greater than 100 to 1; a substrate holder for holding the ferroelectric crystal material with a fixed opposing electrode disposed on a second surface thereof, the first and second surfaces being opposing; and a controller coupled to at least one of the substrate holder and the repositionable electrode. The controller is configured for positioning the repositionable electrode in a first location on a first surface of the ferroelectric crystal material; poling the ferroelectric crystal material with the repositionable electrode at the first location and with the fixed opposing electrode to form a first poled volume; positioning the repositionable electrode in a second location different from the first location on the first surface of the ferroelectric crystal material; and poling the ferroelectric crystal material with the repositionable electrode at the second location and with the fixed opposing electrode to form a second poled volume. The first poled volume and the second poled volume have substantially identical shapes.

### BRIEF DESCRIPTION OF THE SEVERAL VIEWS OF THE DRAWINGS

FIG. 1 is a schematic cross-sectional drawing of a periodically poled ferroelectric crystal substrate with a repositionable electrode.

FIG. 2 is a schematic cross-sectional drawing of a periodically poled ferroelectric crystal substrate with a repositionable electrode.

FIG. 3 is an orthographic pictorial drawing of a periodically poled ferroelectric crystal substrate with a repositionable electrode having a “line” shape.

FIG. 4 is an orthographic pictorial drawing of a periodically poled ferroelectric crystal substrate with a repositionable electrode having a “point” shape.

FIG. 5 is an orthographic pictorial drawing of a poled ferroelectric crystal substrate with an opposing electrode having the same shape as the repositionable electrode.

FIG. 6 is an orthographic pictorial drawing of a periodically poled ferroelectric crystal substrate with a repositionable electrode having multiple “line”-shaped features.

FIG. 7 is an orthographic pictorial drawing of a periodically poled ferroelectric crystal substrate with a repositionable electrode having multiple and widely spaced “line”-shaped features.

FIG. 8 is an orthographic pictorial drawing of a periodically poled ferroelectric crystal substrate with a repositionable electrode having “comb”-shaped features.

FIG. 9 is an orthographic pictorial drawing of a poled ferroelectric crystal substrate with a repositionable electrode having “triangle”-shaped features.

FIG. 10 is an orthographic pictorial drawing of a periodically poled waveguide in a ferroelectric crystal substrate with a repositionable electrode.

### DETAILED DESCRIPTION OF THE INVENTION, INCLUDING THE BEST MODE

Optical devices are manufactured by aligning domains, or poled volumes, in specific patterns in a ferroelectric crystal material. The domains are produced by poling, which includes the application of a poling voltage profile across a pair of electrodes, each on opposing sides of the crystal. Poling causes the domains to become permanently aligned in the crystal, and the domains remain aligned indefinitely or until the crystal is re-poled. Poling voltage profiles for ferroelectric crystal materials may be optimized, as described for segmented electrodes in U.S. Pat. No. 7,145,714 issued Dec. 5, 2006 to Roberts et al., which hereby is incorporated herein in its entirety by reference thereto.

The poling process becomes more challenging as the devices require features that are smaller or are more spatially complicated. For typical poling processes, the electrodes are deposited on the crystal by known lithographic methods, and are removed once the poling process is completed. Lithography can produce fine features, but is expensive and cumbersome. Furthermore, if the pattern to be poled changes slightly, a new mask has to be created, resulting in extra time and expense.

For some devices, the crystal may be poled in a repeated pattern, often with a single spatial feature, such as a line or a triangle. These devices may be produced using a repositionable electrode on one surface of the crystal, rather than a conventional, fixed electrode. The repositionable electrode may have a shaped contact area that corresponds to the spatial feature to be repeated in the poled volume.

An exemplary poling method using this repositionable electrode positions the repositionable electrode on a surface of the crystal, with an opposing electrode on the opposing surface of the crystal, poles the crystal by applying a voltage profile between the electrodes, repositions the repositionable electrode to a new location, poles the crystal in the new location, and repeats for as many instances of the poled feature as desired.

A potential advantage of this exemplary poling method may include any or all of an increased uniformity of the poled features on the same part, an increased uniformity of the poled features from part-to-part, increased flexibility when altering the patterns to be poled, and a reduction in manufacturing expense from not having to use and maintain the lithography equipment.

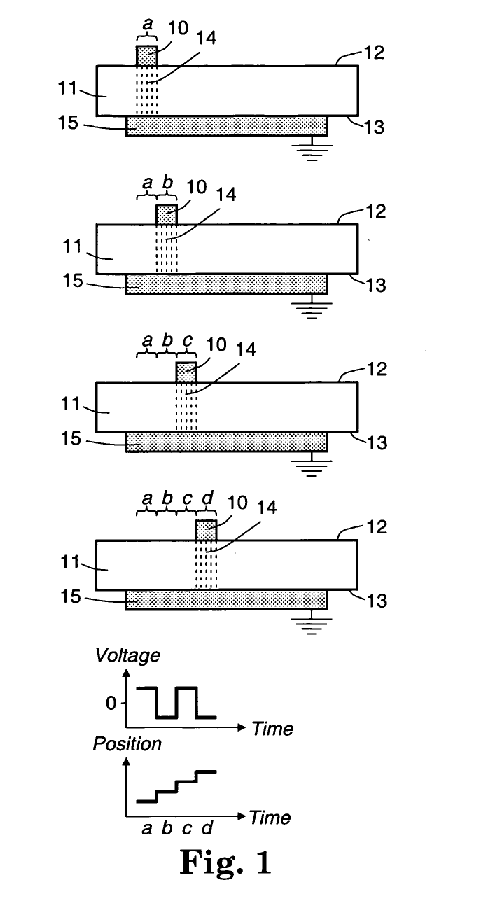

FIG. 1 is a schematic section of an exemplary poling scheme, and is simplified for clarity. A crystal 11 has a repositionable electrode 10 on a repositioning surface 12, and an opposing electrode 15 on an opposing surface 13. The crystal 11 may be single domain, or may have small, undocumented areas that are of opposite domain.

Both electrodes 10 and 15 are typically driven by circuitry that induces a voltage or potential difference between them. The primary quantity of interest during poling is typically the voltage difference between the electrodes, and not the absolute voltage of either electrode. A secondary concern may be the safety of the circuitry, and for safety reasons it may be preferable to ground one of the electrodes, typically the opposing electrode 15, although the repositionable electrode 10 may alternatively be grounded. In FIG. 1, the opposing electrode 15 is shown as being electrically grounded, although this is not a requirement of the poling scheme. In practice, either or neither electrode may be truly grounded.

In the first stage of the poling scheme, denoted by “a” in FIG. 1, a voltage is applied to the repositionable electrode 10. Although the voltage in stage “a” is shown in FIG. 1 as being constant over time, the voltage may optionally have a more complex voltage profile that varies over time.

The voltage profile may be optimized for any or all of a particular geometry, a particular spatial feature size, a particular spatial feature shape, and the particular crystal being poled. For instance, an optimal voltage profile may be determined for an electrode with a long, thin shaped contact area; the electrode may be elongated, and may have a large aspect ratio, such as 100 to 1 or greater, and may optionally be considered to be a “line.” Once the optimal voltage profile is determined for this line-shaped electrode, the same voltage profile may be used each time the line-shaped electrode poles a region in the crystal. Alternatively, the voltage profile may be optimized for one or more poling steps to account for different crystal shapes or geometry, or a defect inside the crystal.

The voltage profile may also take into account any optional movement of the repositionable electrode during poling. For instance, the repositionable electrode may be translated across the surface, and may continue to pole as it is translated. Alternatively, the repositionable electrode may be removed from the surface, and the poling voltage profile may incorporate this movement. For instance, the voltage profile may drop off deliberately as the repositionable electrode is pulled away from the crystal. Alternatively, the voltage profile may drop to a suitable level as the repositionable electrode is translated across the surface of the crystal, rather than pulled away from the crystal.

The voltage produces a strong electric field in a poling region 14 inside the crystal 11. In the poling region 14, the domains in the crystal become aligned along the direction of the electric field. In FIG. 1, the electric field lines are shown as being dashed lines that run vertically between the repositionable electrode 10 and the opposing electrode 15. In practice, the electric field lines may not be truly vertical, but may spread and/or bend in the volume between the electrodes.

In many cases it is desirable that the poling region 14 have roughly the same footprint as the repositionable electrode 10. In other words, if the repositionable electrode 10 has a shaped contact area that subtends a circular area “a”, then the poling region preferably would be a cylinder between the repositionable electrode 10 and the opposing electrode 15 that has a cross-sectional area of roughly “a”. When this occurs, the poling region and the repositionable electrode have substantially identical shapes in respective cross-sections parallel to the repositioning surface of the crystal.

After a predetermined time during which a predetermined voltage profile is applied between the electrodes, the voltage is removed. In the poling region 14, the domains remain aligned even after the voltage is removed; the domain alignment remains permanently or until the crystal is re-poled. Outside the poling region 14, the orientation of the domains remains unchanged.

In many cases, a great deal of effort is spent ensuring that the edge of the poling region 14 falls in a predictable location. This predictability, or control over the location of the edge of the poling region 14, may be referred to as “fidelity”, where a compromise in fidelity may mean an error in the edge location of the poling region 14.

Once the voltage between the electrodes is removed, the repositionable electrode 10 may be moved from location “a” to location “b” on the repositioning surface 12 of the crystal 11. In the simplistic example of FIG. 1, “b” is directly adjacent to “a”, although it may optionally be discrete from “a” or may overlap with a portion of “a”.

The repositioning may be a translation and/or rotation across the repositioning surface 12, with the repositionable electrode 10 remaining in contact throughout the translation and/or rotation. Alternatively, the repositioning may involve removing the repositionable electrode 10 from the repositioning surface 12, then bringing the repositionable electrode 10 into contact with the repositioning surface 12. Typically, there is no significant voltage difference between the electrodes during the repositioning, although a voltage difference may optionally be present.

Note that movement of the electrode with respect to the crystal can be accomplished by moving either or both of the crystal or the electrode. The electrode may be moved to another location either by lifting it off of the surface, translating it to a new location, and lowering it in contact again; or by sliding it along the crystal while maintaining contact with the surface. An alternative method of poling is possible if sliding motion is used by applying the poling voltage while the electrode is in motion. The act of moving, raising and lowering, or modifying the contact of the electrode with the crystal while applying voltage may be used to modify the poling waveform seen at a particular location on the crystal.

Once the repositionable electrode is at location “b”, the next poling stage occurs, with a voltage difference applied between the opposing electrode 15 and the repositionable electrode 10. Similarly, a third and fourth poling stage are shown in FIG. 1, producing poled regions denoted by “c” and “d”. The poling scheme may have as many or as few poling regions as desired.

In the exemplary poling scheme of FIG. 1, the voltage in stages “b” and “d” are opposite in sign to those in stages “a” and “c”, so that the domain alignment in regions “b” and “d” are roughly opposite those in regions “a” and “c”. For instance, if regions “a” and “c” are referred to as being poled “up”, then regions “b” and “d” may be referred to as being poled “down”. Many devices make use of these alternately poled, adjacent regions. For instance, if the edges of the alternately poled regions occur in a periodic manner, then the crystal may exhibit particular wavelength-specific optical properties, with a characteristic wavelength or wavelengths that depend on the period of the poled regions.

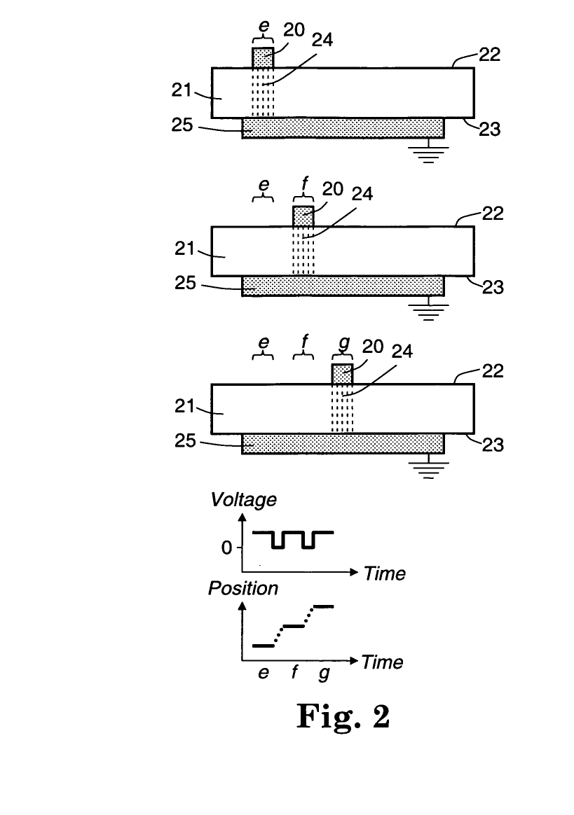

There are other schemes that can produce alternately poled, adjacent regions in the crystal, such as the exemplary scheme shown in FIG. 2. First, the entire crystal 21 may be single domain as manufactured, or may be poled in a particular direction, such as “up” or “down”. Next, the regions “e”, “f” and “g” may be successively poled, but without flipping the sign of the voltage from one region to the next, so that regions “e”, “f” and “g” are all poled “down” or “up”. This results in regions “e”, “f” and “g” being poled in one direction, separated by (unnamed) regions that are poled in the opposite direction. Note that regions “e”, “f” and “g” are separated spatially so that the distance between regions is roughly equal to the size of the regions themselves. Alternatively, the regions between “e”, “f” and “g” may remain unpoled throughout the poling process.

Because the crystal 21 is a single domain prior to the repositioning shown in FIG. 2, the repositioning does not have to explicitly pole the gaps between regions “e”, “f” and “g”. Hence, the voltage difference between the electrodes may be zero or may be less than a particular poling threshold as the positionable electrode 20 is positioned on the repositioning surface 22 of the crystal 21. The amount of time spent between regions “e” and “f”, and between “f” and “g” does not directly affect poling, and may be minimized if throughput and speed of the poling process are optimized.

The opposing electrode 25 is made integral with, is attached to, or is placed in contact with the opposing surface 23 of the crystal.

For some applications, it may be desirable that the electrode be much smaller than the size of the total area of the poled pattern. In some cases, it can be difficult to get good, uniform contact when using electrodes on a separate substrate if the crystal is an unusual size or shape, for instance long and narrow, very thin, very thick, or very small crystal sizes. Variations within the crystal or on its surface may be smaller over shorter distances. Therefore a poling voltage waveform may be chosen that may be more optimal for a smaller area, resulting in better fidelity. Problems in fidelity due to uneven contact pressure or crystal or electrode surfaces that are not uniformly flat may also be somewhat mitigated by using a smaller electrode.

An additional advantage of using a small electrode that is less peak current may be required when poling a smaller area, as compared to a larger one. A smaller peak current places less demand on the voltage supply circuit. Because high voltage waveforms are typically required for poling, a voltage supply circuit with a reduced peak current requirement may be lower cost and may be able to respond at faster speeds. This, in turn, may enable production of voltage waveforms that result in increased poling fidelity.

Furthermore, repositioning the electrode allows for patterns that may not be possible using conventional electrodes. For instance, a poling pattern with poled features that are surrounded by unpoled areas may be challenging to pole using a conventional electrode.

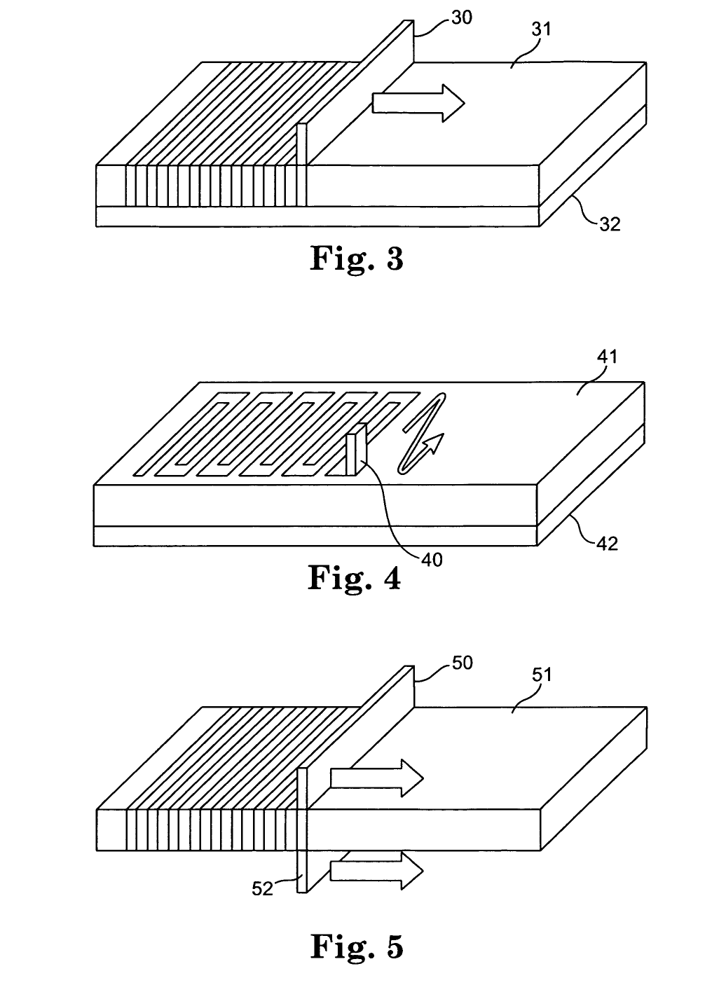

FIG. 3 shows a repositionable electrode 30 being moved across a crystal 31 during a poling process. The crystal 31 has an opposing electrode 32 on the side opposite the repositionable electrode 30. The repositionable electrode 30 in FIG. 3 is essentially bar-shaped, or rectangular with a short dimension and a long dimension. Poling with this bar-shaped electrode may be referred to as “single bar” poling.

Single bar poling may be well-suited for producing periodically poled crystals, which are ferroelectric crystals poled with a pattern of alternating poled and unpoled bars with uniform period, and are commonly used in optical frequency conversion applications. The electrode pattern may be essentially a single line, which poles the crystal one grating bar at a time. Generally, poling periods may be as small as a few microns or less and uniformity of the poling period over long distances may be desired. To ensure this uniformity over long distances, the electrode may be moved with high accuracy and high resolution translation with a computer controlled high precision translation stage. Alternatively, the electrode may move under constant, predictable motion, while the poling voltage may be controlled with high precision timing.

An advantage of single bar poling is that the crystal may be periodically poled with virtually any desired period, unlike conventional poling electrodes in which a unique electrode must be fabricated for each poling period. The period is controlled by the distance traveled after each bar is poled. For improved fidelity, it is desirable that the width of the electrode be smaller than the width of the poled bar.

The width of each poled bar may be controlled by any of a number of methods. For instance, one may vary the amount of overpoling induced by the poling waveform. Alternatively, one may leave the poling voltage on while moving the electrode across the width of the bar. As a third alternative, one may pole each bar in several short steps that make up a total width equal to the desired bar width.

Single bar poling can be used to produce other patterns, in addition to the regular periodicity shown in FIG. 3. For example, single bar poling can produce poled patterns with two different periods on the same crystal, either consecutively or intermingled. Alternatively, single bar poling can produce a periodically poled pattern with varying phase or duty cycle. Furthermore, many other different patterns may be made using a single bar electrode that is shorter than the width of the desired poled area, and optionally translated in two dimensions rather than just one.

Alternatively, an electrode may have a shaped contact area for contacting the crystal surface that is no larger than (and may be smaller than) the smallest feature of the desired pattern, and may be translated across a surface of the crystal 41 to create the features in the periodically poled crystal. This two-dimensional translation and small but non-point spatial extent of the shaped contact area of the electrode allows poled patterns of virtually any shape to be produced. Illustratively, the electrode 40 shown in FIG. 4 has a small, single and uniform rectangular-shaped contact area, and is opposed by opposing electrode 42.

For poling small features, it is desirable that the electrode may not have intricate features that are too closely spaced. Overpoling, in which poling occurs in the area outside the electrode boundary, generally limits the minimum size of features that can be poled. Overpoling may happen more readily when the electric field is higher magnitude outside the electrode area. The electric field usually falls off more rapidly with distance from the electrode and may be oriented in a different direction if there are not other areas in close proximity that are being poled at the same time. As a result, if features in close proximity are poled separately rather than at the same time, overpoling may be reduced, and smaller poled features with higher fidelity may be obtained. To further lessen possible interference from poling neighboring regions, features may be poled in any order and the time between each poling may be made as long as desired. Furthermore, the crystal may be manipulated between polings, for instance, annealing at high temperature, to lessen possible interference from poling neighboring regions.

Another way to reduce overpoling as well as improve fidelity of the poled pattern throughout the thickness of the crystal is to use a smaller size ground. FIG. 5 shows an opposing electrode 52 with a reduced size, on the side of the crystal 51 opposite the repositionable electrode 50. In FIG. 5, the opposing electrode 52 may have roughly the same shape as the repositionable electrode 50 and may be repositioned simultaneously with the repositionable electrode 50.

Because the repositionable electrode may be smaller in size and of a simpler design than the total poling pattern, there may be several possible advantages in the form that the electrode can take.

For instance, a wider variety of metals may be used for the electrode, including metals that may resist being deposited or may not etch using lithographic methods.

In addition, because traditional poling methods may sometimes require insulating materials in the areas that are to remain unpoled during poling, a wider variety of insulating materials may be used. For instance, liquid insulating materials can be readily used. The crystal may, for example, be covered in oil which is displaced by the electrode only in one spot when it is lowered to the surface and fills in again upon raising the electrode.

There are many known interactions with the crystal that can affect and/or improve poling performance, such as the application of pressure, heating, cooling, and/or illumination with laser light. In many cases, it is preferable that these interactions be performed locally, so that only one part of the crystal is affected at a time. These interactions may be performed by the electrode itself, e.g. putting force on the electrode to put pressure on the substrate, or may be performed by a separate device that may move along with the electrode.

A particularly useful quantity that may be measured and/or monitored during poling is conductance, or, equivalently, resistance. Conductance may be found by measuring the current flowing between the electrodes in response to the voltage applied across the electrodes, then dividing the voltage by the current. Resistance is found similarly, only with the current divided by the voltage. Conductance through the bulk may be measured through the crystal using the existing probes, and may be a useful indicator of crystal quality and/or poling quality. Conductance along the surface may be measured by the repositionable electrode in combination with a separate probe electrode that may travel with the repositionable electrode. Both types of conductance measurements may provide useful information and may be used in part to determine future actions on the crystal, such as whether or not to unpole and/or repole certain regions of the crystal, and so forth.

In addition to the strictly repositionable electrodes shown in FIGS. 1 through 5, all or a portion of the electrode may be deposited onto a surface of the crystal. For instance, a particular feature or features of the overall desired poled pattern may be incorporated into a non-repositionable electrode portion, which may be deposited onto a surface of the crystal. The crystal may be poled using the non-repositionable electrode portion to generate the particular feature or features in the poled pattern in the crystal, then the non-repositionable electrode portion may be removed. This depositing, poling and removing may be repeated for different portions of the overall desired poled pattern. For instance, if the desired overall poled pattern has both relative small features and relatively large features, then the poling may be accomplished in two stages, with a deposition, poling and removal of a non-repositionable electrode portion corresponding to the small features, and a deposition, poling and removal of a non-repositionable electrode portion corresponding to the large features. This may be repeated for as many instances as required.

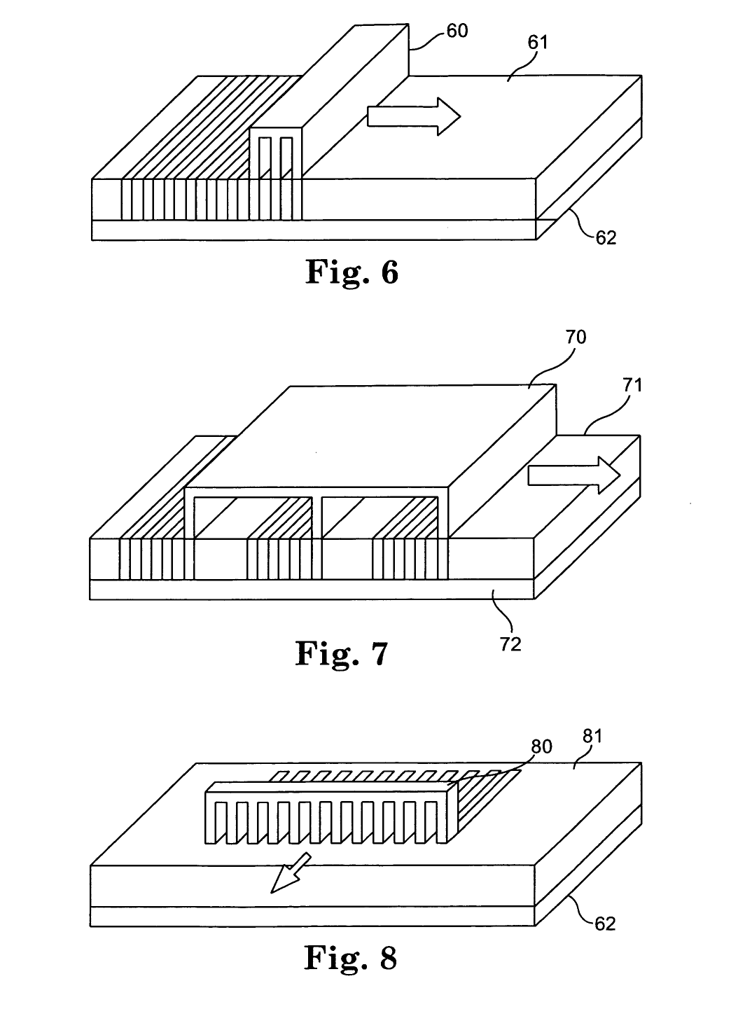

The repositionable electrode may have a more complicated structure than the relatively simple “line” of the electrode 30 (FIG. 3) and the electrode 50 (FIG. 5), or the small rectangular contact area of the electrode 40 (FIG. 4). For instance, FIG. 6 shows an electrode 60 that has multiple “lines”, so that a single application of the poling voltage profile between the repositionable electrode 60 and the opposing electrode 62 produces multiple poled regions in the crystal 61. In this manner, if the repositionable electrode 60 has three “lines”, then the crystal 61 may be poled in one-third the number of applications of the poling voltage profile, thereby saving time during manufacturing. The repositionable electrode 60 may alternatively includes any number of features, such as 1, 2, 3, 4, 5, 6, 8, 10, 16 or any suitable number.

Whereas the spacing between the three line features on exemplary electrode 60 is roughly equal to the desired feature spacing in the poled crystal, the spacing may be much larger. As shown in FIG. 7, for instance, the exemplary repositionable electrode 70 has so-called “line” features that are spaced apart by a distance much larger than the desired feature spacing in the poled crystal 71. In this manner, such an electrode can potentially reduce the required accuracy required during translation. The uniformity of the grating period over long distances is ensured by the electrode itself, and remains unchanged even if the short term translation varies. A frequency converter that uses such a periodically poled crystal is more sensitive to long distance uniformity than to short distance uniformity. The opposing electrode 72 opposes the repositionable electrode 70.

Another repositionable electrode 80 that can reduce the required accuracy during translation is shown in FIG. 8. The repositionable electrode 80 is shaped like a comb, with the period of the comb “teeth” roughly equal to the desired spacing of the poled regions in the crystal 81. As a result, the spacing of the poled features is not significantly affected by the translation of the electrode 80 across the crystal face opposite the opposing electrode 82. Furthermore, each tip in the comb may be connected electrically and poled all at once, or may be electrically isolated and poled individually.

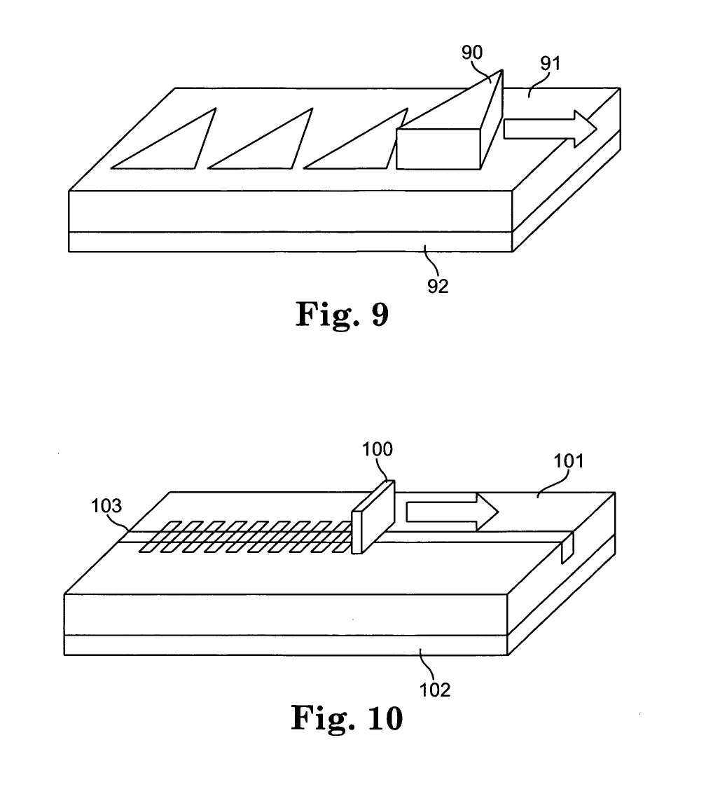

The poled features in FIGS. 1 through 8 are generally linear in nature. In contrast, FIG. 9 shows a repositionable electrode 90 that can pole generally triangular features in the crystal 91 as it is repositioned along the crystal surface opposite the opposing electrode 92. These triangular features may be useful for producing a device that can deflect light in response to an electrical signal. Once the crystal 91 is incorporated into a device, light passing through the crystal 91 parallel to the direction of translation in FIG. 9 may be deflected horizontally in response to a voltage applied to the device. Although the electrode shape is triangular in FIG. 9, it will be understood that any suitable shape may be used for the electrode.

FIG. 10 shows a repositionable electrode 100 poling a crystal 101 containing a waveguide 103 that may confine and guide propagating light. As the electrode is repositioned on the crystal surface opposite the opposing electrode 102, the repositioning may be positioned over the waveguide to pole only the portion of the crystal 101 containing the waveguide 103.

If the desired poled pattern has features of different size or shape, it may be desirable to have two or more different repositionable electrodes, where each repositionable electrode is used to pole a different type of feature in the pattern. The repositionable electrodes may move together or separately.

Note that a repositioning electrode of any pattern and any size or shape may be used to uniformly pole a crystal with a solid pattern, by poling repeatedly, each time moving the electrode to a new location where the electrode covers remaining unpoled areas, until the entire solid area is poled. One potential use for this is to ensure that the crystal may be a single domain (i.e. uniformly poled) prior to patterned poling. Another potential use is to erase prior poling so that a crystal may be repoled.

A system that may incorporate the poling method described herein may include a voltage generator, which may be optionally computer-controlled, an electrode chuck for holding the repositionable electrode, a substrate holder for holding the crystal, and a position controller for repositioning the repositionable electrode. The position controller may be computer-controlled, and may optionally be controlled by the same device that controls the voltage generator. The position controller may operate on the electrode chuck, which in turn, may move the repositionable electrode.

The description of the invention including its applications and advantages as set forth herein is illustrative and is not intended to limit the scope of the invention, which is set forth in the claims. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A method of poling ferroelectric crystal material to form spatial features therein for one or more optical devices, comprising:
positioning a repositionable electrode having a shaped contact area in a first location on a first surface of the ferroelectric crystal material;
poling the ferroelectric crystal material with the repositionable electrode at the first location to form a first poled volume;
positioning the repositionable electrode in a second location different from the first location on the first surface of the ferroelectric crystal material; and
poling the ferroelectric crystal material with the repositionable electrode at the second location to form a second poled volume.

2. The method of claim 1, wherein the first poled volume and the second poled volume have substantially identical shapes.

3. The method of claim 1, wherein the repositionable electrode, the first poled volume, and the second poled volume have substantially identical shapes in respective cross-sections parallel to the first surface.

4. The method of claim 1, wherein the first poled volume and the second poled volume are discrete.

5. The method of claim 1, wherein the first poled volume and the second poled volume overlap.

6. The method of claim 1, further comprising establishing an optimal poling voltage profile for the first and second poled volume poling steps.

7. The method of claim 1, further comprising:
establishing a first optimal poling voltage profile for the first poled volume poling step; and
establishing a second optimal poling voltage profile for the second poled volume poling step, the first and second poling voltage profiles being different.

8. The method of claim 1, further comprising providing an opposing electrode on a second surface of the ferroelectric crystal material, the first and second surfaces of the ferroelectric crystal material being opposing.

9. The method of claim 8, wherein the opposing electrode is fixed.

10. The method of claim 8, wherein the opposing electrode is a repositionable opposing electrode.

11. The method of claim 10, further comprising:
positioning the repositionable opposing electrode in the first location on the second surface of the ferroelectric crystal material, wherein the first poled volume poling step comprises poling the ferroelectric crystal material with the repositionable electrode and the repositionable opposing electrode at the first location to form the first poled volume; and
positioning the repositionable opposing electrode in the second location on the second surface of the ferroelectric crystal material, wherein the second poled volume poling step comprises poling the ferroelectric crystal material with the repositionable electrode and the repositionable opposing electrode at the second location to form the second poled volume.

12. The method of claim 1, wherein the repositionable electrode is stationary during the first poled volume poling step and the second poled volume poling step.

13. The method of claim 1, wherein the repositionable electrode is moving during the first poled volume poling step and the second poled volume poling step.

14. The method of claim 1, wherein the shaped contact area of the repositionable electrode is elongated.

15. The method of claim 14, wherein the shaped contact area of the repositionable electrode has an aspect ratio greater than 100 to 1.

16. The method of claim 1, wherein the shaped contact area of the repositionable electrode is triangular.

17. The method of claim 1, wherein the shaped contact area is of a size smaller than at least one of the spatial features.

18. The method of claim 17, wherein the shaped contact area is of a size smaller than all of the spatial features.

19. The method of claim 1, wherein the repositionable electrode includes a single instance of a spatial feature.

20. The method of claim 1, wherein the repositionable electrode includes multiple instances of a spatial feature.

21. The method of claim 20, wherein the multiple instances of the spatial feature included in the repositionable electrode are spaced more closely than the first and second locations on the first surface of the ferroelectric crystal material.

22. The method of claim 20, wherein the multiple instances of the spatial feature included in the repositionable electrode are spaced farther apart than the first and second locations on the first surface of the ferroelectric crystal material.

23. A method for poling ferroelectric crystal material to form spatial features therein for one or more optical devices, comprising:
positioning a repositionable electrode having a shaped contact area in a first location on a first surface of the ferroelectric crystal material, the shaped contact area being elongated with an aspect ratio greater than 100 to 1;
providing a fixed opposing electrode on a second surface of the ferroelectric crystal material, the first and second surfaces being opposing;
poling the ferroelectric crystal material with the repositionable electrode at the first location and with the fixed opposing electrode to form a first poled volume;
positioning the repositionable electrode in a second location different from the first location on the first surface of the ferroelectric crystal material; and
poling the ferroelectric crystal material with the repositionable electrode at the second location and with the fixed opposing electrode to form a second poled volume;
wherein the first poled volume and the second poled volume have substantially identical shapes.

24. A system for poling ferroelectric crystal material to form spatial features therein for one or more optical devices, comprising:
a voltage generator;
a repositionable electrode coupled to the voltage generator, the repositionable electrode having a shaped contact area;
a substrate holder for holding the ferroelectric crystal material; and
a controller coupled to at least one of the substrate holder and the repositionable electrode, the controller being configured for:
positioning the repositionable electrode in a first location on a first surface of the ferroelectric crystal material;
poling the ferroelectric crystal material with the repositionable electrode at the first location to form a first poled volume;
positioning the repositionable electrode in a second location different from the first location on the first surface of the ferroelectric crystal material; and
poling the ferroelectric crystal material with the repositionable electrode at the second location to form a second poled volume.

25. A system for poling ferroelectric crystal material to form one or more optical devices, comprising:
a voltage generator;
a repositionable electrode coupled to the voltage generator, the repositionable electrode having an elongated shaped contact area with an aspect ratio greater than 100 to 1;
a substrate holder for holding the ferroelectric crystal material with a fixed opposing electrode disposed on a second surface thereof, the first and second surfaces being opposing; and
a controller coupled to at least one of the substrate holder and the repositionable electrode, the controller being configured for:
positioning the repositionable electrode in a first location on a first surface of the ferroelectric crystal material;
poling the ferroelectric crystal material with the repositionable electrode at the first location and with the fixed opposing electrode to form a first poled volume;
positioning the repositionable electrode in a second location different from the first location on the first surface of the ferroelectric crystal material; and
poling the ferroelectric crystal material with the repositionable electrode at the second location and with the fixed opposing electrode to form a second poled volume;
wherein the first poled volume and the second poled volume have substantially identical shapes.
